(19) United States
(12) Patent Application Publication
(10) Pub. No.: US 2012/0061528 A1
(43) Pub. Date: Mar. 15, 2012

(54) Method and apparatus for gripping a tubular

(75) Inventors: Louis Roth, Lafayette, LA (US); Mitch Thibodeaux, Eunice, LA (US); Leo J. Leonards, Lafayette, LA (US); Michael L. LeJeune, Youngsville, LA (US)

(73) Assignee: VOX Rental Tools, Inc.

(21) Appl. No.: 12/807,773

(22) Filed: Sep. 14, 2010

(51) Int. Cl. F16L 3/08

(52) U.S. Cl. 248/65

(57) ABSTRACT

A gripping apparatus for engaging a tubular. In one embodiment, the gripping apparatus comprises a collet structure adapted to receive the end of a tubular therein. A barrel is moveably engaged with the collet structure and is moveable from an open position to a made-up position. The collet structure comprises a substantially cylindrical top section and a bottom section that is divided into a plurality of elongate blades each having a gripping structure formed at an unsupported end thereof. In the made-up position, a flared bottom section of the barrel engages and compresses the respective gripping structures, flexing the blades inwardly and causing engagement of the gripping structures with the sidewall of the tubular. In one embodiment, the barrel is slidably engaged with the collet. In an alternative embodiment, the barrel takes the form of a nut that is threadably engaged with the collet.

### FIELD OF THE INVENTION

The present invention relates generally to oilfield equipment, and more particularly to a method and apparatus for gripping a tubular

### BACKGROUND OF THE INVENTION

Often during the drilling and completion of oil and/or gas (hydrocarbon) wells, it is necessary engage and lift tubular structures, such as pipes, tubing, and other equipment. As used herein, the term “tubular” will be used to refer to any and all tubular and/or generally cylindrical structures, such as lengths of pipe or tubing, lift subs, and like equipment.

Often, lifting a tubular involves engaging the tubular with one or more elevators coupled to a hoist. In some cases, a tubular is provided with a flanged end that is engaged by the elevators. In other cases, however, a tubular may have little or no flange or other structure capable of being engaged by conventional means such as elevators.

### SUMMARY OF THE INVENTION

In view of the foregoing and other considerations, the present invention is directed to a method and apparatus for gripping a tubular, such as a section of pipe.

In one embodiment of the invention, a gripping apparatus comprises a collet structure having an inner diameter sufficient to receive the end of a tubular therein. The apparatus further comprises a barrel structure, at least partially surrounding the collet and in sliding engagement with the collet. The barrel is moveable with respect to the collet from an open position through an intermediate neutral position to a made-up position.

In one embodiment of the invention, the collet is provided with a plurality of elongate blades extending down from a substantially cylindrical collet body. Each blade has a gripping structure on its unsupported end. The barrel has an inwardly flared bottom section adapted to engage the gripping structures when the barrel is moved toward its made-up position. As the gripping apparatus moves to its made-up position, the flared section of the barrel compresses against the collet blades, flexing them inwardly. When fully made-up, the gripping structures are compressed against the inserted tubular. Additional force exerted from beneath the gripping structure tends to strengthen the force with which the gripping structures engage the tubular.

In another embodiment, a gripping apparatus includes a collet body with elongate blades and a barrel structure that is threadably engaged with at least a portion of the collet structure. The collet blades define a threaded pin which engages a threaded box defined on the inner surface of the barrel. After a tubular is inserted into the collet, the barrel is rotated with respect to the collet to move the barrel into a made-up position. In the made-up position, the barrel exerts circumferential force on the collet blades, bringing gripping structures on the ends of the blades into engagement with the tubular.

### BRIEF DESCRIPTION OF THE DRAWINGS

The present invention is best understood with reference to the following detailed description of embodiments of the invention when read in conjunction with the attached drawings, in which like numerals refer to like elements, and in which:

FIG. 1 is a partially cut-away perspective view of a gripping apparatus in accordance with one embodiment of the invention;

FIGS. 2a, 2b, and 2c are side views of the gripping apparatus from FIG. 1 in open, neutral, and made-up positions, respectively;

FIGS. 3a and 3b are side cross sectional views of the gripping apparatus from FIG. 1 in open and made-up positions, respectively;

FIG. 4 is a side view of the collet from the gripping apparatus from FIG. 1;

FIG. 5 is a side view of the barrel from the gripping apparatus from FIG. 1;

FIG. 6 is a perspective view of a gripping apparatus in accordance with an alternative embodiment of the invention;

FIG. 7 is a side view of the gripping apparatus from FIG. 6;

FIGS. 8a and 8b are side cross-sectional views of the gripping apparatus from FIG. 6 is open and made-up positions, respectively; and

FIG. 9 is a side view of the collet from the gripping apparatus from FIG. 6.

### DETAILED DESCRIPTION OF A PREFERRED EMBODIMENT OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering practices for the environment in question. It will be appreciated that such development efforts might be complex and time-consuming, outside the knowledge base of typical laymen, but would nevertheless be a routine undertaking for those of ordinary skill in the relevant fields.

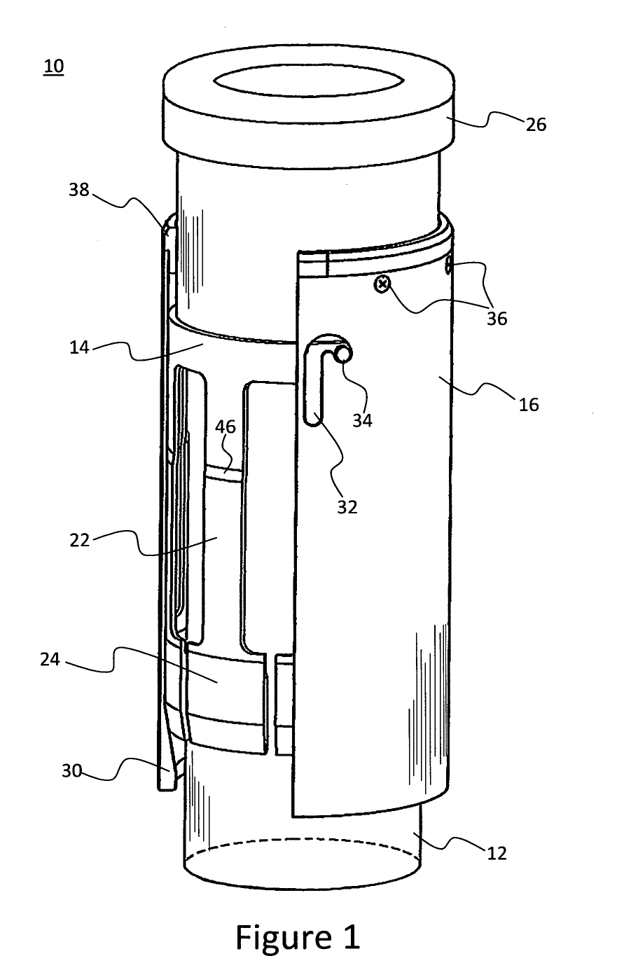

Referring to FIG. 1, there is shown a partially cut-away perspective view of a gripping apparatus 10 in accordance with one embodiment of the invention. Gripping apparatus 10 is shown in FIG. 1 with the end of a tubular 12 inserted therein. Gripping apparatus 10 comprises a collet structure 14 and a barrel 16 slidably engaged with collet 14. (A portion of barrel 16 is cut away in FIG. 1 to more completely expose collet 12. In the disclosed embodiments, gripping structures in accordance with the invention are preferably manufactured from steel.

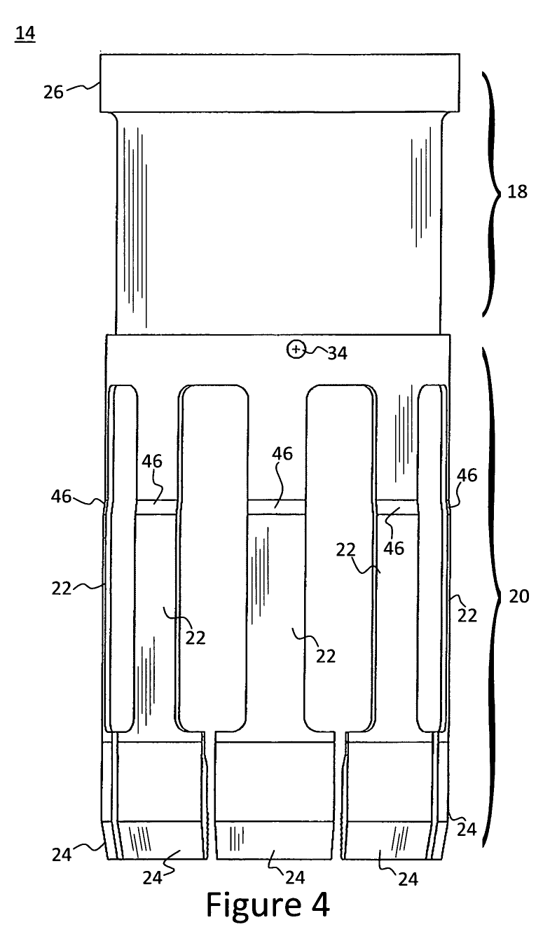

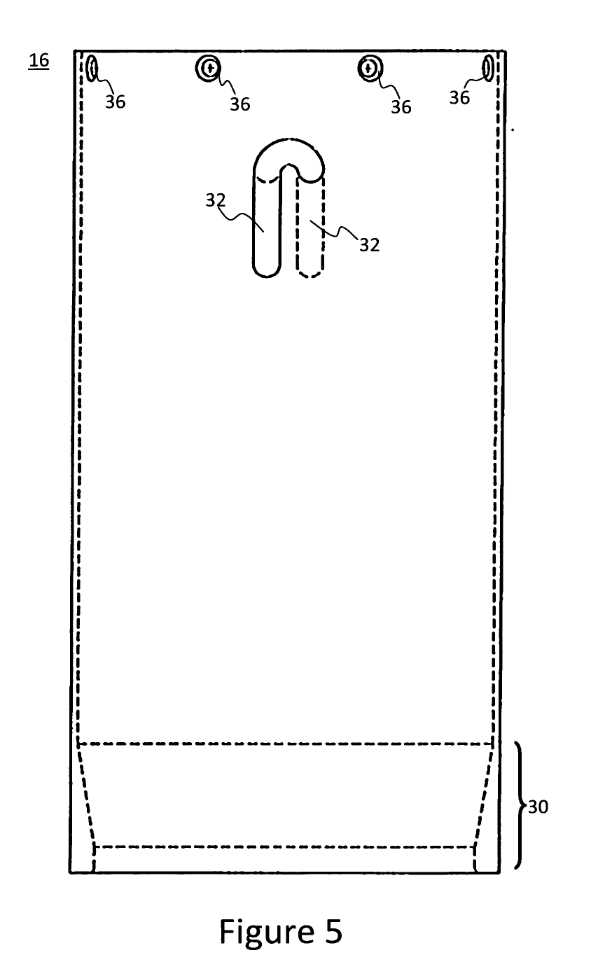

FIG. 4 is a side view of collet 14, and FIG. 5 is a side view of barrel 16. Referring to FIG. 4, collet 14 comprises a substantially cylindrical upper portion 18 and a bottom portion 20 that is divided into a plurality of elongate blades 22. Each blade has a gripping structure 24 at the unsupported end thereof. In the disclosed embodiment, a flange 26 is formed at the top of upper portion 18 of collet 14.

Referring to FIG. 5, barrel 16 is substantially cylindrical, and has an inwardly flared bottom section 30. Barrel 16 has a pair of inverted J-shaped slots 32 formed in its sidewall, the slots 32 being 180 degrees apart from one another in the disclosed embodiment. Barrel 16 is slidably engaged with collet 14. A pair of set screws 34 (see FIG. 4) are received in the slots 32 to limit the extent of movement of barrel 16 with respect to collet 14. A plurality of screws 36 hold in place a flange-like “keeper” 38 at the top of barrel 16. (Keeper 38 is not shown in FIG. 5).

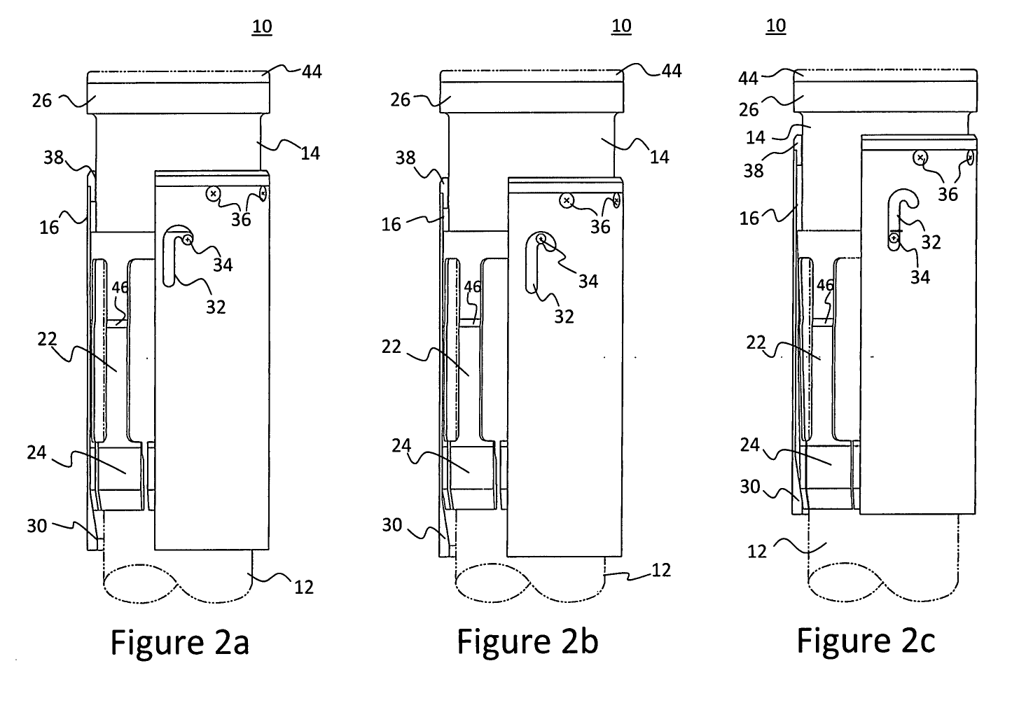

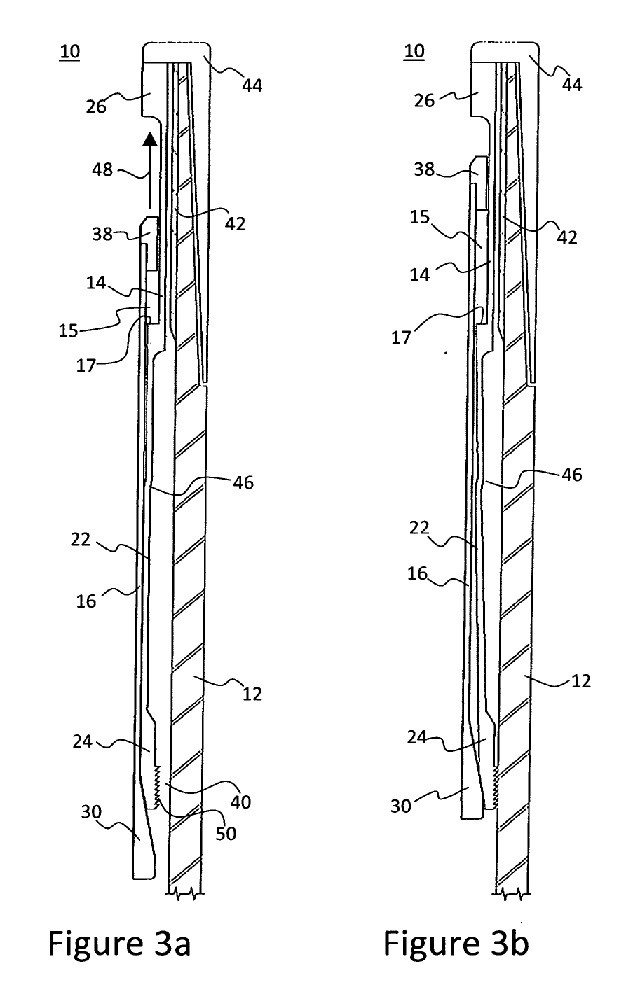

FIG. 2a shows gripping apparatus 10 in a locked open position, with set screw 34 positioned at the short end of the J-shaped slot 32. In the open position, tubular 12 can be inserted into collet 12. FIG. 3a is a cross section of a portion of apparatus 10 in the open position. Note that there is a gap 40 between gripping structure 24 of collet blades 22 and the outer sidewall of tubular 12. Gap 40 permits the insertion of tubular 12 into collet 14 even if, as shown in FIG. 3a, tubular 12 has a slightly flared box end 42. The size of gap 40 may also be increased by providing an outward deflection 46 along the length of blades 22.

Optionally, a thread protector 44 may be installed in the box end 42 of tubular 12. Thread protector may be made of aluminum or of a suitable composite material.

When it is desired to make up a connection between gripping apparatus 10 and a tubular 12, barrel 16 is twisted slightly and moved upward with respect to collet 14, moving set screw 34 first to a neutral position within slot 32, as shown in FIG. 2b, and then to a made-up position with set screw 34 advanced downward through the long end of inverted J-slot 32, as depicted in FIG. 2c. The made-up position is also depicted in the side cross-sectional view of FIG. 3b.

Notably, as barrel 16 is slid upwards to the made-up position (see arrow 48 in FIG. 3a), the inwardly-flared section 30 of barrel 16 comes into contact with and compresses against the gripping structure 24 at the end of each blade 22 of collet 14. This compression causes blades 22 to flex inwardly, bringing the respective gripping structures 24 into contact with the outer side of tubular 12. The gripping structures 24 thereby circumferentially engage the tubular 12, as shown in FIG. 2c and FIG. 3b.

In the presently disclosed embodiment, the gripping structures 24 include a plurality of inward-facing saw-tooth ridges 50. Referring particularly to FIGS. 3a and 3b, in one embodiment of the invention, a spring is disposed in the gap 15 between keeper 38 and a shoulder 17 formed on collet 14. From FIGS. 3a and 3b, it can be seen that gap 15 increases in length (height) as barrel 16 moves from its open position to the made-up position. Providing a spring in gap 15 biases barrel 16 into the made-up position. In one embodiment, the spring (not shown in the Figures) comprises a so-called “wave spring,” such as is available from Smalley Steel Ring Company, Lake Zurich, Ill. A conventional spring may be used in the alternative, as would be apparent to those of ordinary skill in the art.

In accordance with one aspect of the invention, gripping apparatus 10 can be utilized as a structure to be engaged by elevators for the purposes of lifting a tubular 12. Those of ordinary skill in the art would appreciate that such use of apparatus 10 would necessarily involve exertion of upward force on barrel 16. Advantageously, any such upward force will tend to increase the compression force of inwardly flared section 30 of barrel 16 against gripping structures 24, thereby increasing the force and extent with which gripping structure 10 grips or engages the tubular 12.

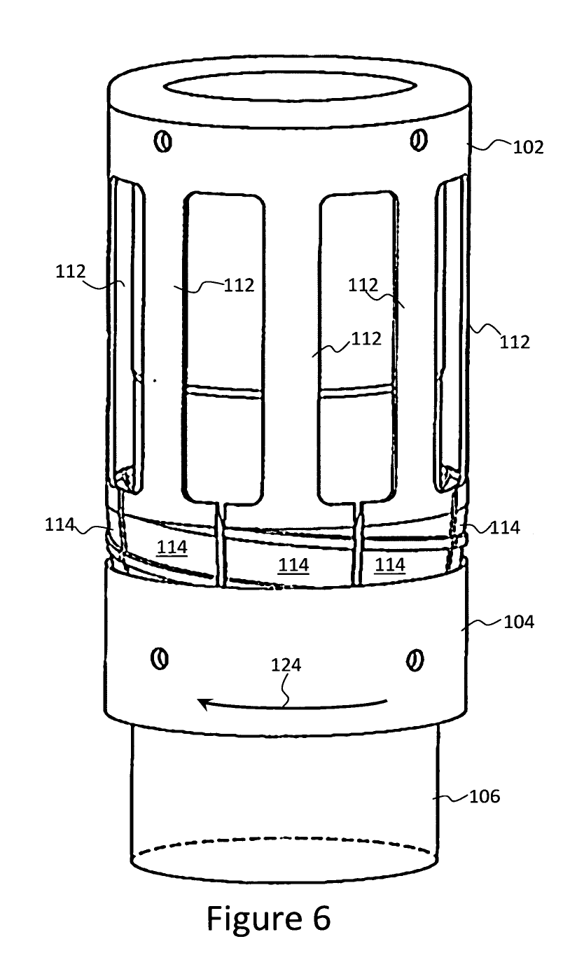

Turning now to FIG. 6, there is shown a perspective view of an alternative embodiment of the invention. The embodiment of FIG. 6 comprises a gripping apparatus 100 including a collet structure 102 and a compression nut 104 in threaded engagement with the collet 102. Gripping apparatus 100 is shown in FIG. 6 with the end of a tubular 106 inserted therein.

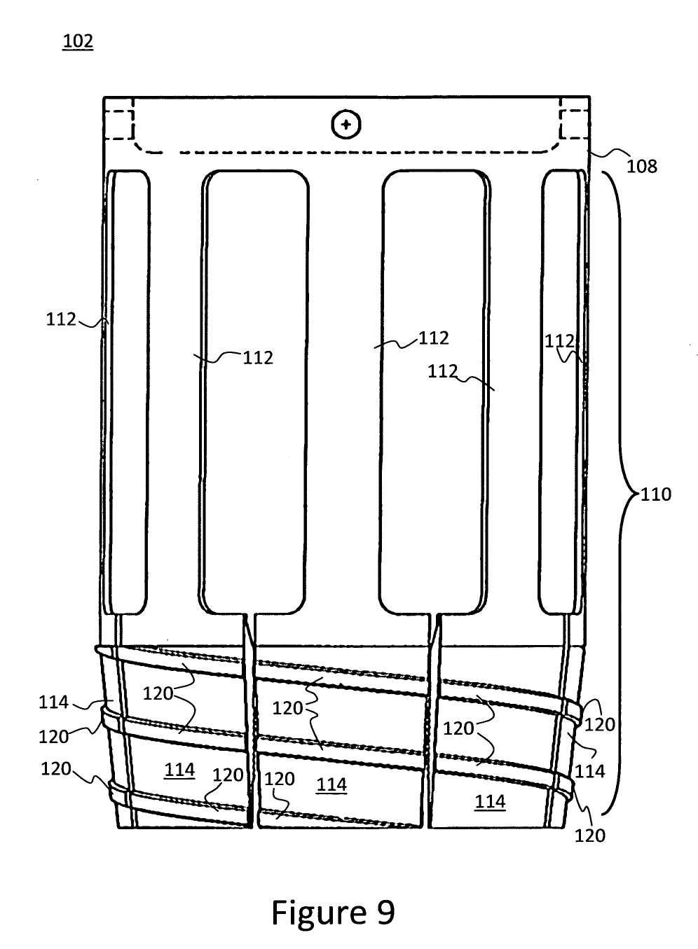

FIG. 9 is a side view of collet 102 from the embodiment of FIG. 6. As shown in FIG. 9, collet 102 comprises a substantially cylindrical upper portion 108 and a bottom portion 110 that, like the embodiment of FIGS. 1-5, is divided into a plurality of elongate blades 112. Each blade 112 has a gripping structure 114 at an unsupported end thereof.

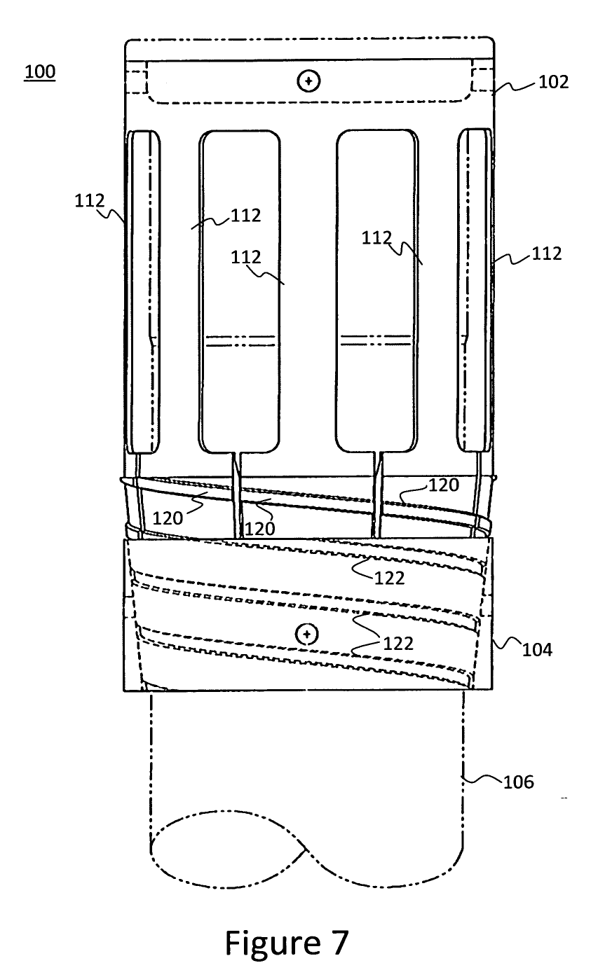

As can be observed in FIG. 9, the portion of each blade including gripping structure 114 is tapered inwardly. On the tapered outer surface of gripping structures 114 is a thread 120 which is continuous except for small gaps between adjacent gripping structures 114. Thread 120 mates with corresponding thread 122 on the interior of nut 104, which has a complementary taper to the taper of gripping structures 114. Thread 122 is shown in dashed lines in FIG. 7.

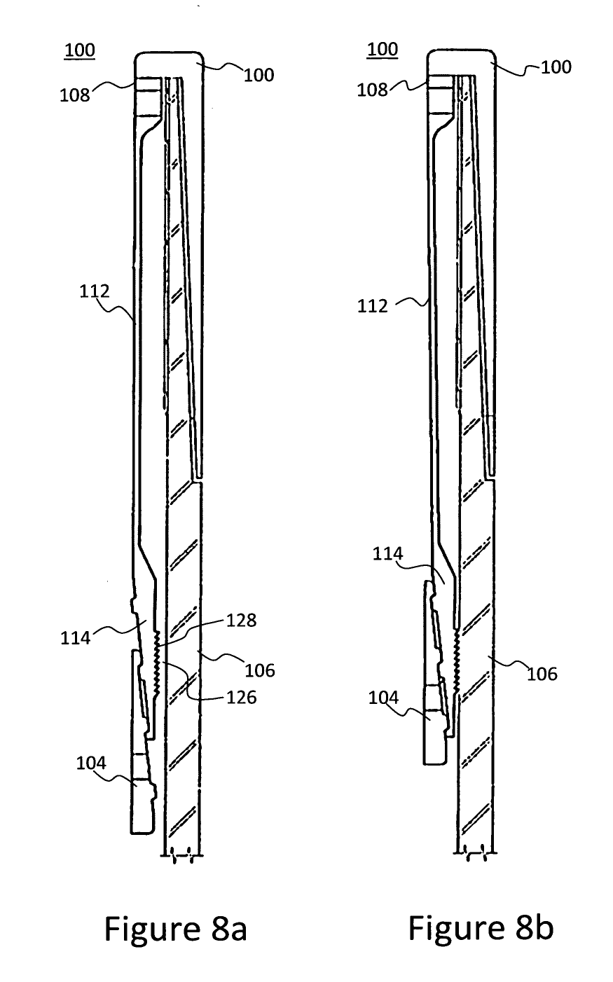

To make up a gripping joint between gripping apparatus 100 and a tubular 106, the tubular 106 is inserted into the bottom of collet 102, with nut 104 either completely removed from collet 102 or with threads 120 and 122 only slightly engaged. Such an “open” position of apparatus 100 is shown in the cross-sectional view of FIG. 8a. Note from FIG. 8a that in the open position, there is a gap 126 between gripping structure 114 and tubular 106. From FIG. 8a, it can also be seen that the inner surface of gripping structure 114 includes a series of sawtooth ridges or teeth 128 for engaging the outer wall of tubular 106.

Next, nut 104 is rotated in the direction of arrow 124 in FIG. 6 into a “made-up” position, such as shown in FIG. 8b. Comparing FIGS. 8a and 8b, it can be observed that as nut 104 is screwed into the made-up position, its inner surface, including threads 122, compress against gripping structures 114, flexing blades 112 inward until teeth 128 engage the sidewall of tubular 106.

As with the embodiment of FIGS. 1-5, the embodiment of FIGS. 6-9 has the advantageous feature that once a connection is made up between gripping apparatus 100 and a tubular 106, any lifting forces applied from below the point of engagement of teeth 128 with tubular 106 will tend to increase the force applied by gripping structure 100 against the sidewall of tubular 106

At least one embodiment of the invention has been described herein solely for the purposes of illustrating the invention in its various aspects. It is contemplated and to be explicitly understood that various substitutions, alterations, and/or modifications, including but not limited to any such implementation variants and options as may have been specifically noted or suggested herein, including inclusion of technological enhancements to any particular method step or system component discovered or developed subsequent to the date of this disclosure, may be made to the disclosed embodiments of the invention without necessarily departing from the technical and legal scope of the invention as defined in the following claims.

What is claimed is:

1. An apparatus for gripping a tubular, comprising:
a collet having dimensions permitting insertion of an end of said tubular therein, said collet having a substantially cylindrical upper portion and a lower portion divided into a plurality of longitudinal flexible blades each having a gripping structure at an unsupported end thereof;
a substantially cylindrical barrel adapted to partially surround said collet, said barrel being in sliding engagement with said collet and having an inwardly-flared bottom section;
wherein said barrel is slidable with respect to said collet between an open position and a made-up position wherein said inwardly-flared bottom section compresses said blades inwardly, causing said gripping structures to contact and circumferentially engage said tubular.

2. An apparatus in accordance with claim 1, wherein said gripping structure comprises a plurality of saw-tooth ridges.

3. An apparatus in accordance with claim 1, wherein lifting forces applied to said gripping structure increase the force with which said gripping structures engage said tubular.
